(19) United States
(12) Patent Application Publication
(10) Pub. No.: US 2004/0033051 A1
(43) Pub. Date: Feb. 19, 2004

(54) Method and system for producing and displaying visual presentations which inhibit off-screen duplication

(76) Inventor: Kiril Kun Wan IP, Hong Kong Sar (HK)

Correspondence Address: IP KUN WAN, KIRIL, FLAT A ,20/F., PO WAH COURT, 29-31 YUK SAV STREET, HAPPY VALLEY, HONG KONG SAR, HK

(21) Appl. No.: 10/219,349

(22) Filed: Aug. 16, 2002

(51) Int. Cl. H04N 9/79; H04N 7/18; H04N 9/47

(52) U.S. Cl. 386/35; 348/460

(57) ABSTRACT

A method and system for preventing a visual video copy being made of a projected image on a screen. In a theater or television or computer screen environment, an image is displayed on a screen by a film projector or a video projector or by the cathode ray tube or the LCD screen. A form of piracy is accomplished by copying the image on the screen with a video camcorder or camera. This invention seeks to produce visual presentations which invention inhibits off-screen copying by camcorders or cameras. A preferred embodiment of the invention comprises of recording means which records images at variable frame rates which rates are either pre-programmed or decided by the user of the means. The variation of the frame rates forms a rate sequence which is recorded simultaneously when the images are recorded. The rate sequence will be read by the display device when the recorded images are displayed such that the images are displayed at the frame rates at which they are recorded. An unauthorized attempt to record the image sequence off the screen without the rate sequence will only record images displayed at unsynchronized rates. It will be extremely difficult if not impossible for an unauthorized person to attempt to synchronize his recording means to the various frame rates of display when the frame rate variation is large. This will make the unauthorized duplicated copy virtually unwatchable.

### CROSS REFERENCE TO THE RELATED APPLICATIONS

Not applicable.

### BACKGROUND

1. Field of Invention

This invention relates to producing and displaying visual presentations including movies and videos which inhibit off-screen duplication by means of visual recording means such as a camera or a video recorder and visual displaying means such as film projectors, video projectors, cathode ray tube or LCD screens.

2. Description of Prior Art

There are various known methods and systems to prevent unauthorized duplication of video image sequences. Many of these known methods and systems are utilized to prevent an unauthorized duplication of a video recording (such as a movie on a video cassette) using a video recording device electrically connected to a video playback device. These methods and systems inhibit potential video pirates from copying the contents of a video cassette or VCDs.

The methods however are unable to prevent a cruder form of unauthorized duplication which can generally be performed using a camera (such as a commercially-available camcorder) to capture and record a video image sequence being displayed on a display device. Although the copy produced is of quality inferior to that of the original, it is still accepted in some parts of the world and pirated copies of movies of this type are generally made and sold.

Some methods have been developed to inhibit duplication of movies or images sequence off the screen. Wrobleski (1) developed a system wherein infra-red images imperceptible to human eyes are projected onto the movies. The infra-red images will be recorded by camcorders of the potential pirates together with the movie or the displayed images. This in theory will make the pirated copy unwatchable. However this method could be got around by using an infra-filter on the camcorder/camera whereby the infra-red images will be filtered out. Further this method could only be applied in a theatre or cinema environment with the use of 2 projectors. If the potential pirate is recording from a TV screen or in a private environment, this method could not apply.

Mead (2) has developed a method by varying the display speed within a small range about 24 frames per second. The suggested range is between 22 to 26 frames per second such that the slight variation could not be detected by human eyes so that the attempted duplication will record images without vertical synchronization. This method will compromise the quality of the original image and audio signals perceived by an ordinary audience and it is not very effective because the range of variation is too small. It is possible for a potential pirate to synchronize the camcorder slightly to obtain a watchable copy of the original display.

Young (3) developed a system such that a standard video signal is modified so that the modified video signal displays a normal image sequence on a standard video monitor device, yet copies made of the modified signal by videotape recorders will reproduce a video signal containing disturbances which cause a generally unviewable display on a standard television or other video monitor device. This method however cannot prevent copying directly of the standard monitor by way of a video camcorder.

Epstein (4) and Mead (5) both developed systems to display visual presentations at random or variable frame rates by way of frame rate generators. Yet they both have shortcomings as the other prior arts that the quality of the display images would be compromised to various extents. The degradation of images would become significant when the displaying frame rates is very different from the rate at which the images are originally recorded.

### SUMMARY

In accordance with the present invention a means for recording images at variable frame rates comprises a means for controlling the rate at which the images frames are recorded.

### OBJECTS AND ADVANTAGES

Accordingly, besides the objects and advantages described in the above patent, several objects and advantages are:

(a) it will be difficult to duplicate the visual presentations produced by the invention off-screen;

(b) the quality of visual presentations recorded by the invention, in particular those for fast moving objects, will be higher than those recorded at the standard 24 frames per second.

Further objects and advantages will become apparent from a consideration of the ensuing description and drawings.

### DRAWING FIGURES

FIG. 1 shows a schematic diagram of a preferred embodiment of the present invention.

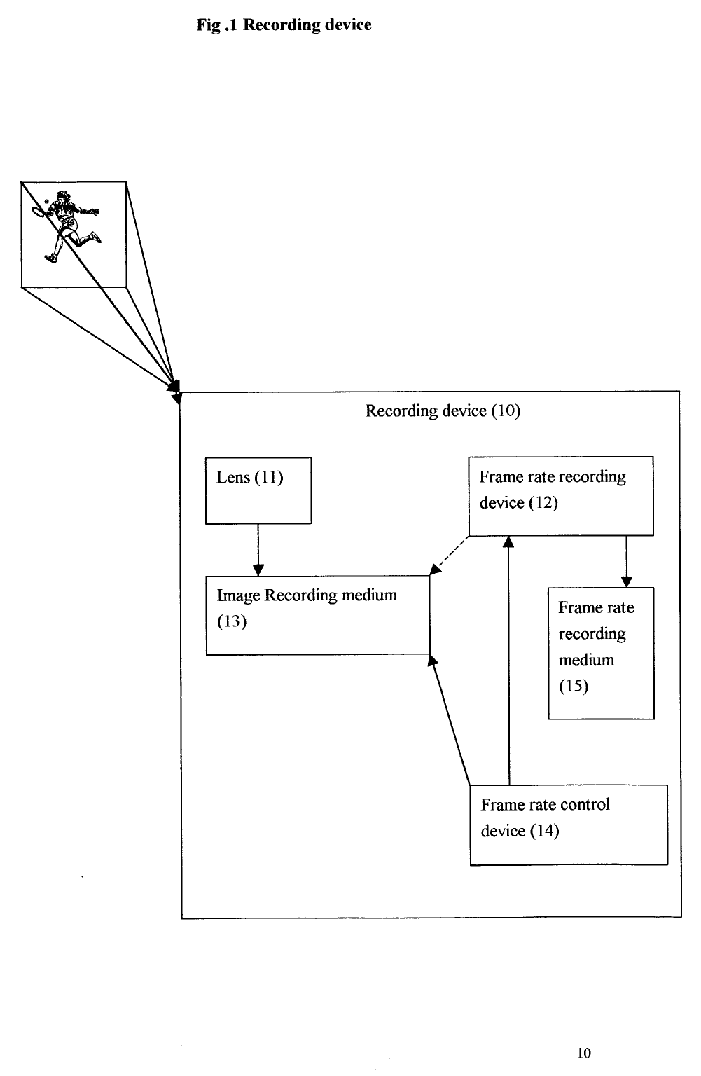

FIG. 2 shows a schematic diagram of a preferred embodiment of the displaying portion of the invention.

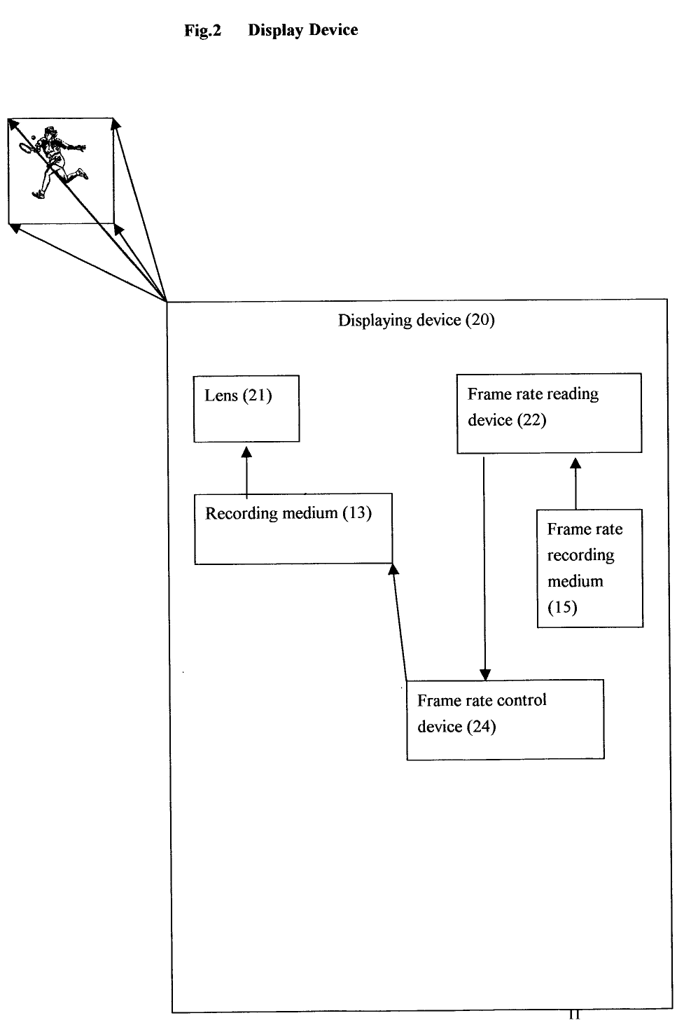

### DESCRIPTION OF THE INVENTION—PREFERRED EMBODIMENT

A preferred embodiment of the invention comprises of a first means for image recording which may record images at variable frame rates. The frame rates are generated by a second means. The rates at which the images are recorded forms a rate sequence. The third means for recording the rate sequence records the rate sequence which may either be recorded on the image recording medium: in the case of movie films or the rate sequence could be recorded on a special track on the film such that it could be read by the display device, and in the event of a video tape, the rate sequence could be recorded on a track on the video tape or recorded separately on another medium such as tapes, a floppy disk or memory stick or other forms of recording medium. The medium storing the rate sequence is transferred together with the image recording medium to the sixth means for displaying.

When the image sequence is displayed on a screen either by the sixth means for displaying including a film projector or video projector or displayed on a television screen, the fifth means reads from the frame rate sequence recording medium first and control the sixth means to display the images at the rates at which they are recorded.

As long as the rate is higher than 24 frames per second, any variation in the frame rate would not be detected by the audience. This will allow the display device to display at a frame rate well higher than the 24 frames per second, say 30 or 36 or even 40 frames per second. Because the range of variation is so large, and virtually limitless, an unauthorized person will hardly be able to adjust his/her camcorder to synchronize with the rate variation. This will make any attempted duplication very difficult if not impossible.

### ABSTRACT

A method and system for preventing a visual video copy being made of a projected image on a screen. In a theater or television or computer screen environment, an image is displayed on a screen by a film projector or a video projector or by the cathode ray tube or the LCD screen. A form of piracy is accomplished by copying the image on the screen with a video camcorder or camera. This invention seeks to produce visual presentations which invention inhibits off-screen copying by camcorders or cameras. A preferred embodiment of the invention comprises of recording means which records images at variable frame rates which rates are either pre-programmed or decided by the user of the means. The variation of the frame rates forms a rate sequence which is recorded simultaneously when the images are recorded. The rate sequence will be read by the display device when the recorded images are displayed such that the images are displayed at the frame rates at which they are recorded. An unauthorized attempt to record the image sequence off the screen without the rate sequence will only record images displayed at unsynchronized rates. It will be extremely difficult if not impossible for an unauthorized person to attempt to synchronize his recording means to the various frame rates of display when the frame rate variation is large. This will make the unauthorized duplicated copy virtually unwatchable.

### DETAILED DESCRIPTION OF THE INVENTION

The recording portion of the preferred embodiment comprises of a first means for recording (10) which includes a camera, a video tape camcorder or digital camcorder with a second means for generating variable frame rates (14).

The images, through lens (11) are projected on to and recorded on the image recording medium (13) which may include films, video tapes, random access memory, memory disk or other recording medium.

The rate at which the images are recorded is controlled by the second means for generating variable frame rates (14) which may include a variable speed motor in the case the recording medium (13) is film or video tape; and in the case the recording medium (13) is random access memory, the second means for generating variable frame rates may include an integrated circuit which controls the rate at which the image frames are recorded.

The thirds means for recording (12) records the sequence of rates at which the image frames are recorded. The frame rates may be recorded directly onto the image recording medium (13) or on a separate recording medium (15). The frame rate recording medium may include film, tapes, magnetic disk, random access memory or other similar medium.

The displaying portion of the preferred embodiment (20) includes a film projector or a video projector which includes a lens (21) through which the images read from image recording medium (13) are projected and displayed on screen.

The displaying portion of the preferred embodiment (24) may include a variable speed motor in the case the image recording medium (13) is film or video tape; and in the case the recording medium (13) is random access memory, the frame rate control device may include an integrated circuit which controls the rate at which the image frames are displayed.

The rate at which the image frames are displayed is read by the frame rate reading device (22) either directly from the image recording medium (13) or from the frame rate recording medium (15) as the case may be.

It is noted that the present invention may be used in a wide variety of different constructions encompassing many alternatives, modifications, and variations which are apparent to those with ordinary skill in the art. Accordingly, the present invention is intended to embrace all such alternatives, modifications, and variations as fall within the spirit and broad scope of the appended claims.

I claim:

1. A method and system for recording and displaying an image sequence to inhibit unauthorized duplications thereof by another image recording means, the image sequence having a plurality of image frames, the method and system comprising:
a first means for recording to record image frames at variable frame rates;
a second means for generating variable frame rates at which the image frames are recorded;
a third means for recording in sequence the frame rates at which the image frames are recorded;
a fourth means for transferring the rate sequence recorded by the third means to a sixth means for displaying;
a fifth means for reading the rate sequence transferred through the fourth means from the third means;
a sixth means for displaying the image sequence at frame rates at which the corresponding image frames are recorded and read by the fifth means;

2. The system of claim 1 whereby the first means recording image frames at variable frame rates enables a user to record image sequence, e.g. a movie or a video at frame rates generated by the second means for generating variable frame rates;

3. The system of claim 1 further comprises of a second means which generates frame rates at which the image frames are recorded. The second means enables a user to record the image frames at frame rates higher than the usual 24 frames per second.

4. The system of claim 1 further comprises of a third means which records the frame rates at which the image frames are recorded.

5. The system of claim 1 further comprises of a fourth means through which the rate sequence recorded by the third means in claim 4 herein may be transferred to the fifth means for displaying;

6. The system of claim 1 further comprises of a fifth means for reading the frame rate sequence transferred through the fourth means from the third means;

7. The system of claim 1 further comprises of a sixth means for displaying images at frame rates according to the rate sequence read by the fifth means and transferred from the fifth means in claim 6.
Notes:

| | |
|---|---|
| (1) Wrobleski | Method and system for preventing off-screen copying |
| | of a video or film presentation. |
| | Patent no.: US006018374 |
| | Date of patent: Jan. 25, 2000 |
| (2) Mead D.C. | Method and system for anti-piracy using frame rate |
| | dithering. |
| | Patent no. : US005680454 |
| | Date of patent: Oct. 21, 1997 |
| (3) Young P.L. | Method and apparatus for modifying a video signal to |
| | inhibit unauthorized videotape recording and subsequent |
| | reproduction thereof |
| | Patent no. : US005585929 A |
| | Date of patent: Dec. 17, 1999 |
| (4) Epstein M | A method and device for preventing piracy of video |
| | material from theatre screen |
| | Patent no. : WO99/67950 |
| | Date of patent: Dec. 29, 1999 |
| (5) Mead D.C. | Systems and methods for preventing camcorder piracy of |
| | motion picture images. |
| | Patent no.: WO 00/743 66 A2 |
| | Date of patent: Dec. 7, 2000 |
